(19) United States
(12) Patent Application Publication
(10) Pub. No.: US 2012/0079860 A1
(43) Pub. Date: Apr. 5, 2012

(54) IMPROVEMENTS TO KEY-OPERATED PIN TUMBLER LOCKS

(75) Inventor: Martin Pink, Nottingham (GB)

(73) Assignees: UAP Limited, Walshaw Bury (GB); Martin Pink, Nottingham (GB)

(21) Appl. No.: 13/318,567

(22) PCT Filed: May 12, 2010
(86) PCT No.: PCT/GB10/00951

§ 371 Date: Dec. 20, 2011

(30) Foreign Application Priority Data
May 14, 2009 (GB) 0908260.3
Jul. 6, 2009 (GB) 0911601.3
Sep. 1, 2009 (GB) 0915089.7

(51) Int. Cl. E05B 23/00; E05B 19/04

(52) U.S. Cl. 70/351; 70/408

(57) ABSTRACT

A key-operated pin tumbler lock has a shell in which is rotatably disposed a plug that defines a keyway and a plurality of bores. The bores communicate with the keyway through the plug and in a locked position of the lock communicate with corresponding bores formed in the shell. A plurality of spring-loaded pin stacks are located within the bores and are moveable within the bores against the spring-loading by a key inserted in the keyway into a position wherein the plug can be rotated relative to the shell. A stop means is provided in one of the bores and is adapted to engage the pin stack which is located therein such that a key pin of the stack is prevented from penetrating into the plug to a level reached by key pins of the other pin stacks.

CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC

Not applicable.

### BACKGROUND OF THE INVENTION

1. Field of the Invention

The present invention relates to key-operated pin tumbler locks and to keys for locking and unlocking these locks.

2. Description of Related Art Including Information Disclosed Under 37 CFR 1.97 and 37 CFR 1.98

In a conventional key-operated pin tumbler lock, as shown schematically in FIGS. 1 and 2, an outer shell or cylinder 1 of the lock has a cylindrical hole housing a rotatable core or plug 2. To open the lock, the plug 2 must rotate relative to the shell 1 in order to operate a cam or lever mechanism (not shown) that controls withdrawal of a latch or bolt (not shown). A keyway 3 is formed in the plug 2 to allow a key 4 to be inserted into the plug 2, as shown in FIG. 2. Communicating with the keyway 3 is a series of identical bores 5, typically five or six in number although only four are shown in Figs. 1 and 2, that are drilled at right angles to the keyway 3 through the plug 2 and into the shell 1. Within each of these bores 5 is located a pin stack that comprises a spring-loaded driver pin 6 stacked over a key pin 7. A ledge or other detent 8 within the plug 2 is used to prevent the pin stack from falling out of the bore.

When a key 4 is inserted into the keyway 3, teeth 9 on the blade of the key 4 act on the key pins 7 and push them, against the force of the spring-loaded driver pins 6, into the bores 5. If the correct key 4 is fully inserted into the keyway 3, notches 10 between the teeth align with the key pins 7 and are of such a depth in the key 4 that the interfaces 11 between all of the key pins 7 and the driver pins 6 are aligned at the point 12 where the shell 1 and the plug 2 meet. This point is called the shear point as should all of the interfaces 11 align with it, as shown in FIG. 2, the plug 2 can be rotated within the shell 1 by the body of the key 4 to open the lock. However, when there is no key 4 in the keyway 3 or when a wrong key is inserted into the keyway 3, the interfaces 11 between the key pins 7 and their associated driver pins 6 do not align and the driver pins 6 straddle the shear point so that the plug 2 cannot be turned relative to the shell 1.

It will be appreciated that although the bores 5 are identical and the detents 8 are located at the same level within the plug 2, the heights of the pin stacks in each of the bores 5 are different from one another. Locks vary because the combinations of heights of the pin stacks in every lock are deliberately designed to be different. The bitting of the lock refers to the particular combination of pin stack heights in the lock. Though each manufacturer is different, usually there is a range of as many as nine possible heights of key pins 7 in a bitting range as the heights of the driver pins 6 in any given lock are usually identical. The heights in this range increase incrementally. Bittings can, therefore, be represented as a code that is usually a series of integers, for example 316482, where each integer can be translated from a key code chart or from a bitting code list issued by the lock manufacturer into a pin height. It will be appreciated that the bitting code for a lock instructs a locksmith how a key is to be cut for that lock. Each digit in the bitting code corresponds to a different cut or notch 9 on the key and represents the depth at which the key must be cut. In addition, the position of the number in the sequence indicates the location of the cut on the key blank. Depending on the maker, the bitting sequence can be from bow-to-tip along the blade of the key, the bow being the larger, handle portion of the key, or can be from tip-to-bow. Conventional locks typically have between four and six pin stacks and the bitting code will, therefore, have a corresponding number of digits.

Lock bumping is a known technique for opening a conventional pin tumbler lock of the type described above and is usually employed by locksmiths for opening locks when the correct key has been lost. However, recently criminals have started to take advantage of the technique using a specially-made ‘bump key’. Such a key can be used to open all locks of the same type and typically comprises a key similar to that used for the locks in question but with identically sized notches that will interact with all of the key pins 7 of the lock. The bitting of these notches is usually at the greatest depth of the bitting range for the lock. To ‘bump’ the lock, the bump key is inserted into in the lock one notch out along the keyway 3 so that it protrudes slightly from the lock. A sudden quick impact is then applied to the key to force it deeper into the keyway 3. This transmits an instantaneous force to all of the key pins 7 of the lock which in turn transmit the force to their associated driver pins 6. As the movement of the key pin 7 and the driver pin 6 in a pin stack is highly elastic, the instantaneous force applied to each driver pin 6 causes it to separate from its key pin 7 into the shell 1 for a fraction of a second before being returned into contact with the key pin 7 by the spring loading. However, during the fraction of a second when the pins 6 and 7 are apart, it is possible to rotate the core 2 in the shell 1 because all of the pin stacks are activated at the same time.

One known countermeasure to prevent lock bumping is to employ a damping oil or gel which is used to fill the plug 2. The oil or gel damps the transmission of forces within the pin stacks so that there is no separation between the key pin 7 and the driver pin 6. This means that the lock cannot be opened. The problem with this countermeasure, however, is that solvents can be employed by criminals to destroy the damping effect of the oil or gel prior to bumping.

### BRIEF SUMMARY OF THE INVENTION

The object of the present invention is to provide a pin tumbler lock which uses mechanical means rather than chemical means to obviate or substantially mitigate its susceptibility of being opened by a lock bumping technique.

According to a first aspect of the present invention there is provided a key-operated pin tumbler lock comprising
a shell;
a plug rotatably disposed relative to the shell and defining a keyway and a plurality of bores that communicate with the keyway through the plug and that, in a locked position of the lock, communicate with corresponding bores formed in the shell;
a plurality of spring-loaded pin stacks that are located within all bar one of the bores and that are moveable within the bores against the spring-loading by a key inserted in the keyway into a position wherein the plug can be rotated relative to the shell;
a first additional pin stack that is located in said one bore; and
a stop means provided in said one bore and adapted to engage the additional pin stack which is located therein such that a key pin of the stack is prevented from penetrating into the plug to a level reached by key pins of the other pin stacks.

In a conventional lock, when there is no key inserted into the lock as shown in FIG. 1, all of the key pins 7 of the pin stacks are urged against the detents 8 in the bores by the spring loading applied to the driver pints 6 so that they are all at the same level in the keyway 3. Hence, when a bump key is inserted into the keyway 3, it contacts and is therefore able to impart a force to every key pin 7. However, in the present invention, the key pin in the bore comprising the stop means is prevented from penetrating into the plug 2 as far as the other key pins and can only be acted upon by a specially adapted key, as is described further below. A conventional bump key is unable to contact this key pin. Consequently, it is not possible to bump the lock.

Preferably, said plurality of spring-loaded pin stacks each have a height randomly selected from a bitting range, and a second additional pin stack is provided in the lock that has a height greater than the greatest height of said bitting range.

It will be appreciated that such a lock has a lock combination which comprises the widest possible range of pin stack heights, the first and second additional pin stacks having heights beyond the ends of the normal bitting range, namely at levels 0 and 10. The hardest locks to bump are those where the lock combination includes a wide range of pin stack heights. The chances of this lock being successfully bumped are therefore reduced to a negligible level.

Preferably, the stop means comprises a constriction in said one bore against which the key pin of the key stack located in said bore bears.

Preferably also, the constriction comprises a shoulder in a wall defining said one bore formed by a portion of the bore having a smaller diameter than the rest of the bore. Advantageously, the key pin of the key stack located in said one bore is adapted to bear against said shoulder by defining a shoulder formed by a free end of the key pin having smaller diameter that the rest of the key pin.

Preferably also, the key pin of the stack located in said one bore is prevented from penetrating into the plug beyond a level equal to that of the lowest level in a bitting range of the other pin stacks.

Preferably also, the driver pin of the stack located in said one bore penetrates into the plug by a distance that is at least half the distance between the stop means and an interface between the shell and the plug.

Preferably also, the height of the second additional pin stack is greater than the greatest height of said bitting range by a distance that is at least equal to an increment of said bitting range.

Preferably also, the pin stacks each comprise a driver pin and a key pin with an interface therebetween and wherein the interface of the key pin and the driver pin of the second additional pin stack coincides with a shear point of the lock when there is no key inserted into the lock.

Preferably also, the pin stacks each comprise a driver pin and a key pin, the driver pins of said plurality of pin stacks being of equal height and the driver pin of the first additional pin stack having a height no greater than the height of the aforesaid driver pins of the plurality of pin stacks.

Preferably also, the first and second additional pin stacks are spring-loaded using springs of different weights from the pin stacks of those of the plurality of pin stacks.

Preferably also, the first and second additional pin stacks are spring-loaded using springs of different weights from each other.

Preferably also, said plurality of pin stacks comprises at least four pin stacks.

Preferably also, at least one of the driver pins of any of the pin stacks is made of a hardened carbon steel or piano wire.

Preferably also, at least one of the driver pins made of a hardened carbon steel or piano wire is longer than those not made of a hardened carbon steel or piano wire.

According to a second aspect of the present invention there is provided a key adapted to lock and to unlock a key-operated pin tumbler lock according to the first aspect of the present invention.

According to a third aspect of the present invention there is provided a key adapted to lock and to unlock a key-operated pin tumbler lock comprising a blade defining a plurality of notches that each have a depth randomly selected from a bitting range, and wherein the blade comprises an unnotched portion at a position that would otherwise be notched as one of said plurality of notches forming part of said bitting range.

Preferably, the blade comprises an additional notch that has a depth greater than the greatest depth of said bitting range.

### BRIEF DESCRIPTION OF THE DRAWINGS

Embodiments of the present invention will now be described by way of example with reference to the accompanying drawings, in which:

FIGS. 1 and 2 are schematic longitudinal cross sections of a conventional key-operated pin tumbler lock mechanism showing respectively the lock in a locked position and the lock with a key inserted that unlocks the lock;

FIG. 3 is a schematic longitudinal cross section of a first embodiment of key-operated pin tumbler lock according to the first aspect of the present invention;

FIG. 4 is a transverse cross-section along the line IV-IV in FIG. 3;

FIG. 5 is a view similar to FIG. 3 but with a key inserted that unlocks the lock;

FIG. 6 is a view similar to FIG. 5 but with a ‘bump key’ inserted;

FIG. 7 is a view similar to FIG. 3 but of a second embodiment of key-operated pin tumbler lock according to the present invention;

FIG. 8 is a view similar to FIG. 7 but with a key inserted that unlocks the lock; and

FIG. 9 is a view similar to FIG. 7 but with a ‘bump key’ inserted.

### DETAILED DESCRIPTION OF THE INVENTION

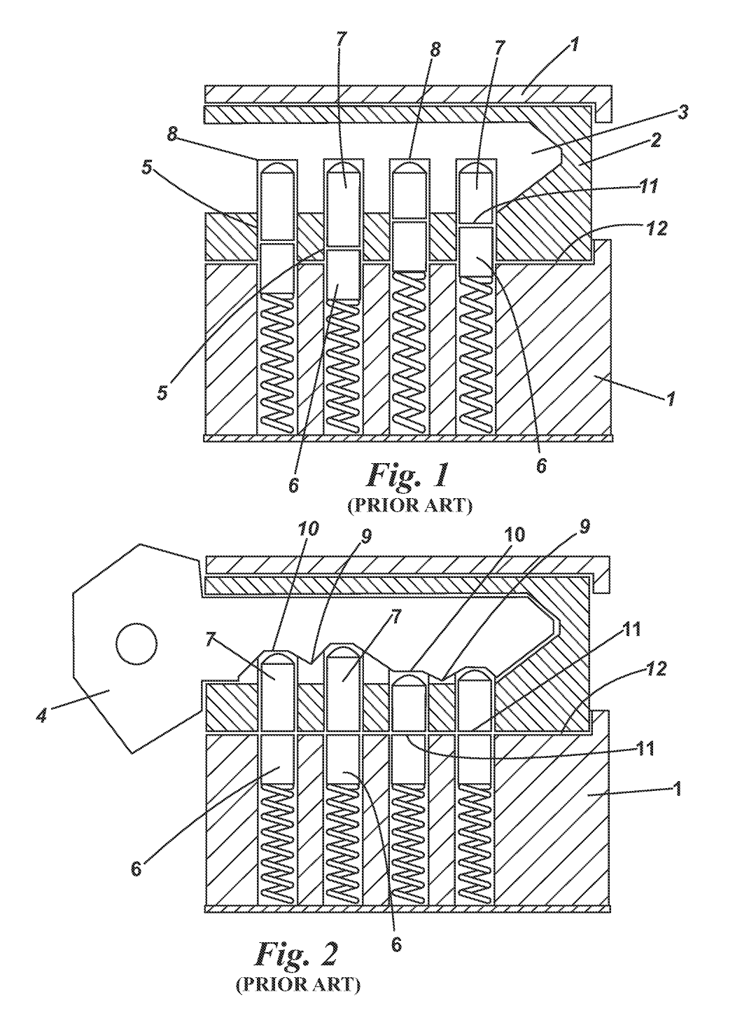

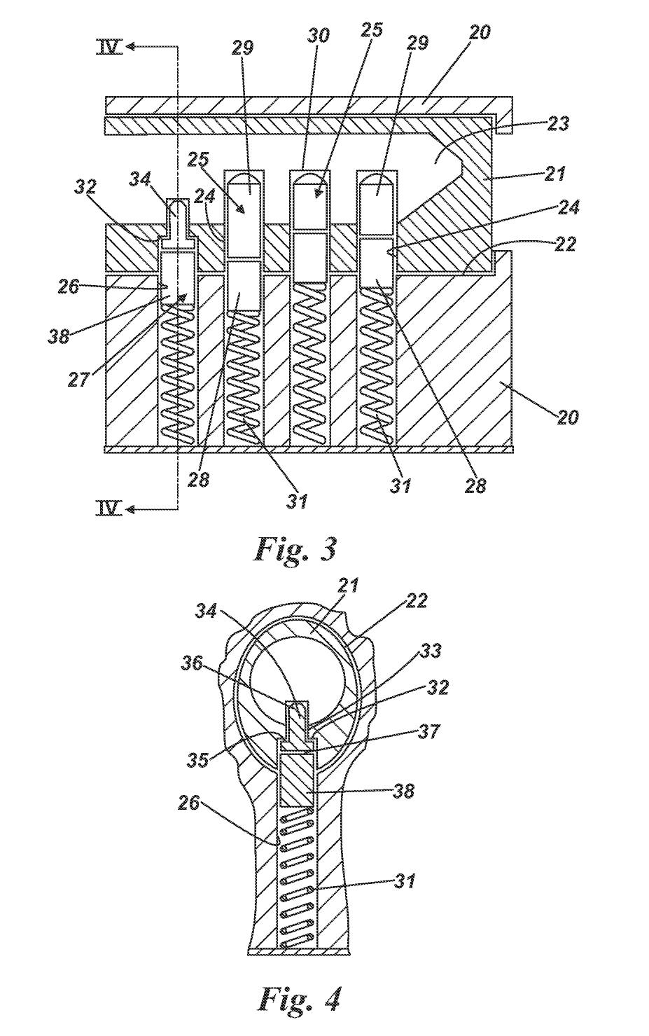

As shown in FIGS. 3 and 4, a key-operated cylindrical pin tumbler lock in accordance with the invention is similar to a conventional pin tumbler lock as described above with reference to FIGS. 1 and 2 in that it comprises a shell 20, a plug 21 defining a shear point 22 with the shell 20, a keyway 23 formed in the plug 21 and a plurality of bores 24 disposed at right angles to the longitudinal axis of the plug 21 along the length of the keyway. Each of the bores 24 contains a pin stack 25 but, unlike a conventional lock, at least one of these bores, labelled 26, differs from the rest in a manner as is described below. A pin stack 27 that is located in the bore 26 also differs from the other pin stacks 25 in a manner as is also described below. The other pin stacks 25 each comprise a spring-loaded driver pin 28 stacked with a key pin 29, a ledge or similar detent 30 within the plug 21 preventing the pin stack 25 from falling out of the bore 24. The driver pins 28 are all of a similar height with identical spring loadings 31. The key pins 29, however, are of differing heights selected randomly from a conventional bitting range. Such a bitting range may, for example, comprise up to nine different heights that increase incrementally from a lowest height to a highest height.

The bore 26 differs from the other bores 24 by the provision of a stop means that prevents the key pin 34 of the pin stack 37 from penetrating into the plug 21 to the level reached by key pins 39 of the other pin stacks 25. In the illustrated embodiment, the stop means comprises a constriction in the form of a shoulder 32 in the wall of the plug 21 defining the bore 26. The shoulder 32 is formed by a portion 33 of the bore having a smaller diameter than the rest of the bore. It should be appreciated, however, that the stop means could take other forms, for example a projection into the bore 26 such as a rib or similar that can act on the key pin 34.

In the illustrated embodiment, the key pin 34 of the pin stack 27 located in the bore 26 is adapted to bear against the shoulder 32 by defining a shoulder 35 itself. This shoulder 35 is formed by the upper or free end 36 of the key pin 34 having smaller diameter that the rest of the key pin. Hence, the end 36 of the key pin 34 is prevented from penetrating into the plug 21 to the same level as the key pins of the other pin stacks 25. Preferably, the key pin 34 is prevented from penetrating into the plug 21 beyond a level equal to that of the lowest level in the bitting range of the other pin stacks 25. This has implications for the keys that can be used to open locks according to the invention, as is described in more detail below

It will be appreciated that of necessity the key pin 34 is of a smaller height than the other key pins 29 as the interface 37 between the key pin 34 and its driver pin 38 must still align at the shear point 22 of the key where the shell 20 and the plug 21 interface. Typically, the end 36 of the key pin 34 has a length or height of around 1.4 mm and the key pin 34 has an overall length or height of 2.4 mm. In addition, when there is no key inserted into the lock the driver pin 38 preferably penetrates into the plug 21 by a distance that is at least half the distance between the shoulder 32 and the shear point 22. In practice, this means that the driver pin 38 always straddles the shear point 22 and prevents the lock from opening if bumping of the lock is attempted.

In a typical lock of the type according to the invention the bores 26 are usually of the order of 2.8 mm in diameter. In the present invention, the main portion of the bore 26 also has a diameter of 2.8 mm but the constricted portion 33 preferably has a diameter of 2.5 mm so that the shoulder 32 has a width of 0.4 mm around the circumference of the portion 33. Likewise, the pin stacks 25 typically comprise pins that have a diameter of 2.8 mm but preferably in the present invention the key pin 34 has an end 36 which has a diameter of 2.4 mm so that the shoulder 35 also has a width of 0.4 mm. These dimensions ensure a good overlap between the two shoulders 32 and 35. In addition, when there is no key in the lock the driver pin 38 preferably penetrates into the plug 21 by around 1.5 mm.

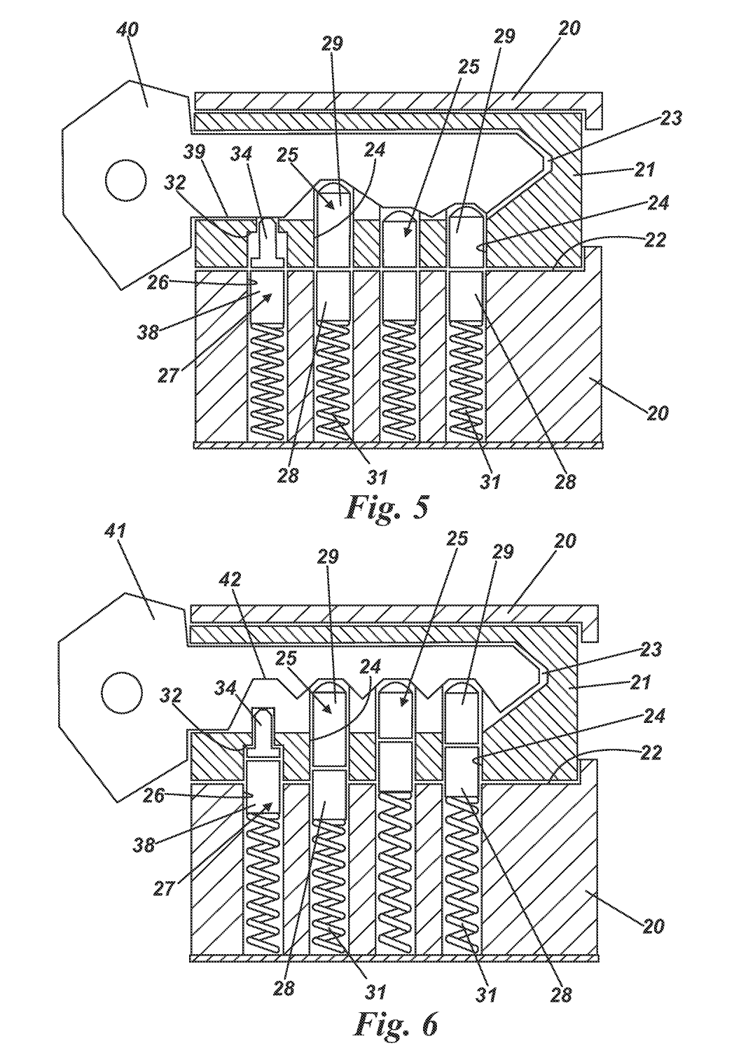

As the key pin 34 does not penetrate into the plug 21 to the same extent as the other key pins 29, a portion 39 of a key 40 that acts on the key pin 34 to unlock the lock is substantially unnotched, as shown in FIG. 5. It will be appreciated that keys 40 which incorporate a substantially unnotched portion in a combination with portions notched in accordance with a conventional bitting pattern are also novel over conventional keys which operate pin tumbler locks.

As described above, a conventional ‘bump key’ 41 is made with identically sized notches 42 that will interact with all of the key pins of a conventional lock. As the bitting of these notches is usually at the greatest depth of the bitting range for the lock, if such a key 41 is inserted into a lock of the present invention, as shown in FIG. 6, it is unable to contact the key pin 34 of the pin stack 27. This makes it impossible to bump the lock with such a key 41 as the key pin 34 and the driver pin 38 will always remain in contact with one another with the driver pin 38 straddling the shear point 22.

While FIGS. 3 to 6 show a lock having four bores and pin stacks, in practice in order to give a good range of possible lock combinations a lock according to the present invention preferably has at least four pin stacks 25 plus one pin stack 27. The pins 34 and 38 of the pin stack 27 can be made of any suitable material such as is used for the other pins stacks 25, for example brass, and do not need to be made of specially hardened materials such as piano wire or hardened steel. However, this can be advantageous, as is explained further below.

It will be appreciated that the use of the pin stack 27 gives an additional pin height, at level 0, in the bitting range. This substantially increases the total number of lock combinations for any given number of pin stacks and therefore further increases the security of the lock.

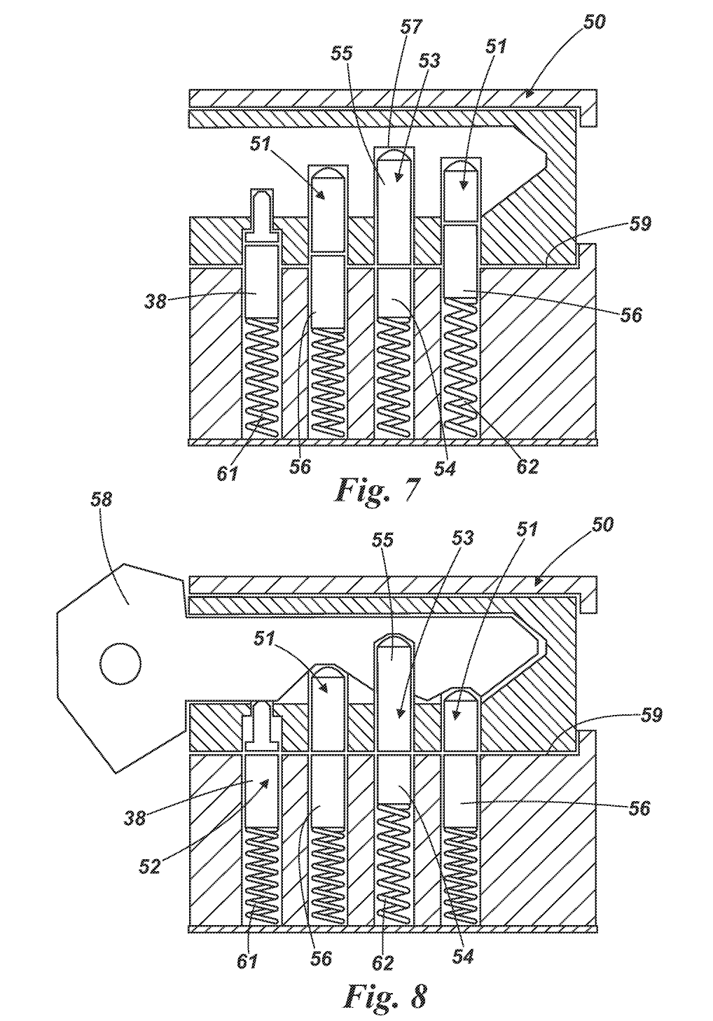

In a development of the invention, a second additional pin stack is provided in the lock that has a height greater than the greatest height of said bitting range. Such a lock has a lock combination which comprises the widest possible range of pin stack heights, the first and second additional pin stacks having heights beyond the ends of the normal bitting range, namely at levels 0 and 10. As the hardest locks to bump are those where the lock combination includes a wide range of pin stack heights, the chances of such a lock being successfully bumped are therefore reduced to a negligible level. This further development of the invention will now be described with reference to FIGS. 7 to 9.

The lock 50 shown in FIGS. 7 to 9 has four pin stacks, two of which comprise conventional pin stacks 51 of differing heights selected randomly from a conventional bitting range. A third pin stack 52 is similar to the pin stack 27 described above, with a key pin 34 and a driver pin 38, and a fourth pin stack 53 also differs from the pin stacks 51. This pin stack 53 comprises a spring-loaded driver pin 54 and a key pin 55 but it has a height greater than the greatest height of the bitting range used for the other pin stacks 51. Preferably, its height is greater than the greatest height of the bitting range by a distance that is at least equal to an increment of the bitting range.

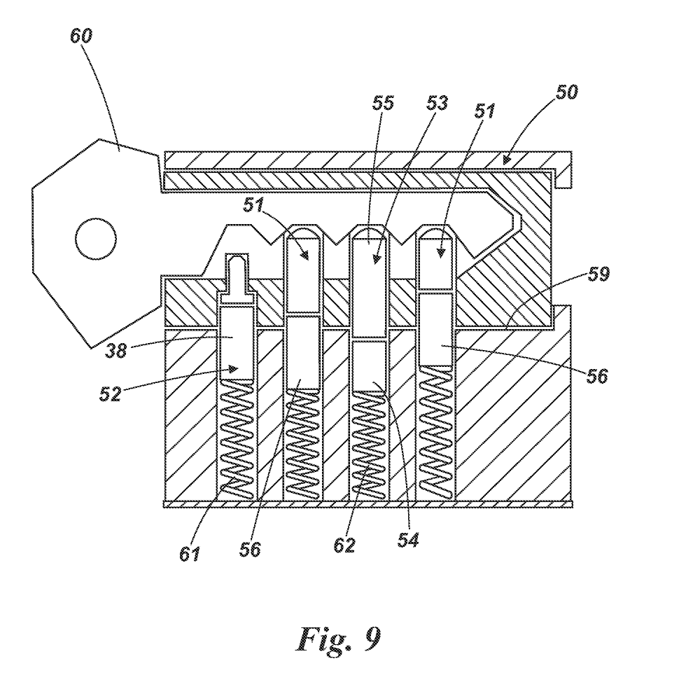

As shown in FIG. 7, whereas the driver pins 56 and 38 of the pin stacks 51 and 52 are equal in height, the driver pin 54 of the pin stack 53 can have a different height. Usually it is shorter than the driver pins 56, 38 and preferably has a height no greater than the height of the other driver pins 56, 38. This means that the key pin 55 has a long length and requires a deeply cut notch 57 to be cut in an appropriate position on the correct key 58 for the lock. Preferably, the pin stack 53 is arranged so that when no key is inserted into the lock, the interface between the key pin 55 and its driver pin 54 is at the shear point 59 of the lock, as shown in FIG. 7. This means that any slight movement of the pin stack 53 into its bore will cause the key pin 55 to move to straddle the shear point 59 and to prevent opening of the lock. If, therefore, an incorrect key is inserted in the lock, the key pin 55 straddles the shear point 59 to a significant degree. In particular, if a conventional ‘bump key’ 60 is inserted into the lock, as shown in FIG. 9, the bump key 60 itself will force the key pin 55 to straddle the shear point 59 so that the lock can never be bumped open. In addition, such a bump key 60 is unlikely to be notched such that it can act on the pin stack 52. This is because the bitting of the bump key typically will match the bitting of the pin stacks 51.

If the bump key 60 were to be changed to match the lower bitting depth of the pin stack 52, then the pin stack 53 will be forced into a locking position with the key pin 55 straddling the share point 59. Alternatively, if the bump key 60 were changed to match the greater bitting depth of the pin stack 53 it would have no effect on the pin stack 52 that would remain in a position with the driver pin 38 straddling the shear point 59 during the bumping operation. In addition, the bump key itself would be weak and easily damaged in an attempted bumping operation as all of the notches would have to be cut deeply into the body of the key 60.

Hence, the pin stacks 52 and 53 work in combination with one another, one or other of them always acting to retain the lock closed if the lock is ever subjected to a bumping attack. The combination of these pin stacks 52 and 53 in a lock 50 produces a lock with a lock combination which combines the widest possible range of pin stack heights, the heights of both the pin stacks 52 and 53 being outside the normal range. The combination of these levels in a lock, typically 0 and 10, makes the lock virtually impossible to bump successfully.

In practice, the pin stacks 52 and 53 are located in random positions relative to each other and to the position of the other pin stacks 51 within the lock. In order to give a good range of possible lock combinations, preferably there are at least four conventional pin stacks 51 plus one pin stack 52 and one pin stack 53 in the lock. It should be appreciated, however, that more than one pin stack 52 or 53 could be included in the combination. Assuming that there are ten positions in the bitting range used for a lock with six pin stacks, then this produces around 67,000 different lock combinations if unwise combinations are excluded. Such unwise combinations include those where the pin stacks 51 are identical or only vary in height from one another by a single increment.

Bumping of such a lock can also be hindered by altering the spring loading of the pin stacks 52 and 53 so that they ‘bounce’ at different rates from the pin stacks 51. Typically this is done by spring-loading the driver pins 38 and 54 with springs 61 and 62 that have different weights or are made of different materials from those of the pin stacks 51. In addition, the springs 61 and 62 of the pins 38 and 51 can also be made different from one another. This means that during a bumping operation the springs of the pin stacks 51, 52, 53 all react differently, making it more unlikely that any instantaneous force applied to the driver pins will separate them from their respective key pins such that the gaps between then will coincide with the shear point 59 at the same time.

It will be appreciated that the present invention can be used in any pin tumbler lock to reduce the risk of it being bumped. However, pin tumbler locks have other vulnerabilities. One of them is physical assault wherein the lock is actually broken and the plug 21 of the lock is extracted. Various methods are employed to do this, for example a stainless steel screw can be screwed into the plug and the plug 21 extracted using a claw hammer. Sometimes, such a screw is used to split the shell 20 so that the plug 21 can be extracted. Plug extraction is made easier because the pins of the pin stacks are typically made of brass and are readily bent and snapped. The present invention can be adapted to prevent removal of the plug 21 by replacing one or more of the driver pins of the lock with oversized driver pins made of hardened steel or from piano wire, which is tempered high-carbon steel, also known as “spring steel”. The driver pins 28, 38, 54, 56, 57 can also be made of hardened steel or piano wire and at least some of them can also be made longer than would be the case in a conventional lock to hinder plug extraction. Many conventional locks are use an ‘anti-snap’ feature where the shell 20 of the lock is provided with a weak point, typically by being split or cut through purposely to create a weak point where the shell 20 will snap if tampered with leaving the bulk of the shell 20 in place. The use of oversized, hardened steel driver pins 28, 38, 54, 56 in such a lock enhances its resistance to attack as in this case the weak, end part of the shell 20 will split off and the hardened steel pins will help keep the remaining part of the plug intact.

1. A key-operated pin tumbler lock comprising
a shell;
a plug rotatably disposed relative to the shell and defining a keyway and a plurality of bores that communicate with the keyway through the plug and that, in a locked position of the lock, communicate with corresponding bores formed in the shell;
a plurality of spring-loaded pin stacks that are located within all bar one of the bores and that are moveable within the bores against the spring-loading by a key inserted in the keyway into a position wherein the plug can be rotated relative to the shell;
a first additional pin stack that is located in said one bore; and
a stop means provided in said one bore and adapted to engage the additional pin stack which is located therein such that a key pin of the stack is prevented from penetrating into the plug to a level reached by key pins of the other pin stacks.

2. A lock as claimed in claim 1, wherein said plurality of spring-loaded pin stacks each have a height randomly selected from a bitting range, and wherein a second additional pin stack is provided in the lock that has a height greater than the greatest height of said bitting range.

3. A lock as claimed in claim 1, wherein the stop means comprises a constriction in said one bore against which the key pin of the key stack located in said bore bears.

4. A lock as claimed in claim 3, wherein the constriction comprises a shoulder in a wall defining said one bore formed by a portion of the bore having a smaller diameter than the rest of the bore.

5. A lock as claimed in claim 4, wherein the key pin of the key stack located in said one bore is adapted to bear against said shoulder by defining a shoulder formed by a free end of the key pin having smaller diameter that the rest of the key pin.

6. A lock as claimed in claim 1, wherein the key pin of the stack located in said one bore is prevented from penetrating into the plug beyond a level equal to that of the lowest level in a bitting range of the other pin stacks.

7. A lock as claimed in claim 1, wherein the driver pin of the stack located in said one bore penetrates into the plug by a distance that is at least half the distance between the stop means and an interface between the shell and the plug.

8. A lock as claimed in claim 2, wherein the height of the second additional pin stack is greater than the greatest height of said bitting range by a distance that is at least equal to an increment of said bitting range.

9. A lock as claimed in claim 8, wherein the pin stacks each comprise a driver pin and a key pin with an interface therebetween and wherein the interface of the key pin and the driver pin of the second additional pin stack coincides with a shear point of the lock when there is no key inserted into the lock.

10. A lock as claimed in claim 2, wherein the pin stacks each comprise a driver pin and a key pin, the driver pins of said plurality of pin stacks being of equal height and the driver pin of the first additional pin stack having a height no greater than the height of the aforesaid driver pins of the plurality of pin stacks.

11. A lock as claimed in claim 2, wherein the first and second additional pin stacks are spring-loaded using springs of different weights from the pin stacks of those of the plurality of pin stacks.

12. A lock as claimed in claim 2, wherein the first and second additional pin stacks are spring-loaded using springs of different weights from each other.

13. A lock as claimed in claim 1, wherein said plurality of pin stacks comprises at least four pin stacks.

14. A lock as claimed in claim 1, wherein at least one of the driver pins of any of the pin stacks is made of a hardened carbon steel or piano wire.

15. A lock as claimed in claim 14, wherein at least one of the driver pins made of a hardened carbon steel or piano wire is longer than those not made of a hardened carbon steel or piano wire.

16. A key adapted to lock and to unlock a key-operated pin tumbler lock as claimed in claim 1.

17. A key adapted to lock and to unlock a key-operated pin tumbler lock comprising a blade defining a plurality of notches that each have a depth randomly selected from a bitting range, and wherein the blade comprises an unnotched portion at a position that would otherwise be notched as one of said plurality of notches forming part of said bitting range.

18. A key as claimed in claim 17, wherein the blade comprises an additional notch that has a depth greater than the greatest depth of said bitting range.
